(19) United States
(12) Patent Application Publication
(10) Pub. No.: US 2008/0296266 A1
(43) Pub. Date: Dec. 4, 2008

(54) PROCESSING APPARATUS

(75) Inventors: Toru Okada, Kawasaki (JP); Yutaka Noda, Kawasaki (JP); Seiichi Shimoura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/125,602

(22) Filed: May 22, 2008

(30) Foreign Application Priority Data
May 30, 2007 (JP) 2007-144259

(51) Int. Cl. B23K 3/04; B23K 1/00

(52) U.S. Cl. 219/85.16; 219/85.22

(57) ABSTRACT

A processing head is supported for pivotal movement around a pivot point in a processing apparatus. An urging member applies an urging force to the processing head at the pivot point. The processing apparatus allows establishment of point contact between the urging member and the processing head. When the surface of an object inclines from a predetermined attitude, the processing head is allowed to follow the inclination of the surface. The processing head is allowed to establish a predetermined attitude relative to the surface of the object. The processing head thus reliably enables a predetermined action to the object as desired.

### BACKGROUND OF THE INVENTION

1. Field of the Invention

The present invention relates to a processing apparatus having a processing head urged against an object.

2. Description of the Prior Art

A solder bonding apparatus enables the simultaneous heating of all pieces of solder, as disclosed in Japanese Patent Laid-open Publication No. 55-24726, for example. Such a solder bonding apparatus includes a plate-shaped heater tip supported for swinging movement around a horizontal axis. The tip end of the heater tip defines an edge on a straight line. Even if the pieces of solder are arranged on a straight line inclined from a horizontal plane within an imaginary vertical plane perpendicular to the horizontal axis, the edge of the heater tip is allowed to contact with all the pieces of solder through the swinging movement around the horizontal axis.

A carriage assembly is employed within a hard disk drive. Head suspensions are mounted on a carriage block in the carriage assembly. The flexible printed wiring boards of the head suspensions are bonded to a flexible printed wiring board on the carriage block. Solder is utilized to bond. The flexible printed wiring board is received on an aluminum plate on the carriage block. The surface of the flexible printed wiring board is inclined to the horizontal plane in response to the deformation of the aluminum plate. A conventional heater tip cannot be allowed to uniformly contact with the entire inclined surface.

### SUMMARY OF THE INVENTION

It is accordingly an object of the present invention to provide a processing apparatus capable of allowing a processing head, such as a heater tip, to reliably follow an inclined surface of an object. In particular, it is an object of the present invention to provide a method of controlling a heating apparatus applicable to such a processing apparatus.

According to a first aspect of the present invention, there is provided a processing apparatus comprising: a processing head supported for relative movement around a pivot point; and an urging member applying an urging force to the processing head at the pivot point.

The processing apparatus allows establishment of point contact between the urging member and the processing head. When the surface of an object inclines from a predetermined attitude, the processing head is allowed to follow the inclination of the surface. The processing head is allowed to establish a predetermined attitude relative to the surface of the object. The processing head thus reliably enables a predetermined action to the object as desired.

The processing apparatus may further comprise: a support member supporting the weight of the processing head, said support member allowing the tip end of the processing head to project downward in the vertical direction; and a driving mechanism enabling upward and downward movements of the support member in the vertical direction. The processing head is supported upward in the vertical direction from below in the processing apparatus. When the support member moves downward in the vertical direction, the tip end of the processing head abuts against the object. The processing head is lifted upward in response to the reaction from the support member. The processing head is in this manner allowed to follow the inclination of the surface of the object. When the support member moves upward in the vertical direction, the processing head is separated from the object.

The processing apparatus may further comprise a heater block brought in contact with the processing head for heating the processing head to a predetermined temperature. The processing apparatus allows a processing head to serve as a heating head. The processing apparatus thus serves as a heating apparatus. Such a heating apparatus can be utilized for a soldering process, for example. Even when pieces of solder are dispersed within a predetermined two-dimensional plane, the processing head is allowed to uniformly apply heat to all the pieces of solder. This reliably realizes a simultaneous melting of pieces of solder.

Here, the processing apparatus may further comprise a lifting mechanism designed to lift the heater block in the vertical direction. The processing apparatus allows the lifting mechanism to separate the heater block from the processing head. Cooling of the processing head is accelerated. In this case, the urging member keeps the application of the urging force to the processing head. The processing head serves to hold the object at a predetermined position during cooling of the processing head.

Here, the processing apparatus may further comprise a ventilation mechanism enabling discharge of airflow from an opening opposed to the surface of the processing head. The airflow is directed to the processing head. The airflow absorbs the heat of the processing head. Cooling of the processing head is further accelerated.

The processing apparatus may further comprise: a first thermal sensor incorporated in the processing head, the first thermal sensor outputting a first temperature information specifying a detected temperature; and a second thermal sensor incorporated in the heater block, the second thermal senor outputting a second temperature information specifying a detected temperature. The output of the first and second thermal sensors can be utilized to control the heating of the heater block. While the heater block contacts with the processing head, the output of the first thermal sensor may be employed to control the heating of the heater block. The processing head can thus reliably be heated to a predetermined temperature. On the other hand, when the heater block is spaced from the processing head, the output of the second thermal sensor may be employed to control the heating of the heater block. The heater block can thus reliably be prevented from an excessive rise in temperature during the cooling of the processing head.

According to a second aspect of the present invention, there is provided a method of controlling a heating apparatus, comprising: heating a heat transfer block to a predetermined temperature using a heater block in contact with the heat transfer block, said heat transfer block being brought into contact with an object; and separating the heater block from the heat transfer block for cooling the heat transfer block.

The method allows the heater block to serve to heat the heat transfer block. The heat transfer block is brought in contact with an object after heated to a predetermined temperature. The object is reliably heated. When the heat transfer block is separated from the heater block, the temperature of the heat transfer block drops. Here, the heat transfer block can keep contacting with the object. The heat transfer block serves to hold the object at a predetermined position and simultaneously serves to accelerate cooling of the object.

The temperature of the heater block may be kept at a predetermined temperature while the heat transfer block is cooled. The temperature of the heater block can be kept at a higher temperature when the heat transfer block is cooled. After the cooling of the heat transfer block has been completed, the heat transfer block can thus immediately be heated based on the contact with the heater block. The heat transfer block can thus alternately be subjected to heating and cooling in a shorter period. A processing time of the heating apparatus is reduced. The heating apparatus may employ a ceramic heater for heating the heater block, for example. The ceramic heater is unable to realize an alternate repetition of heating and cooling in a shorter period. However, the ceramic heater is capable of generating a sufficient amount of heat with a relatively small amount of electric current. Wires are thus allowed to have a reduced diameter for supplying electric current. This contributes to realization of a change in the attitude of the ceramic heater with a relatively small driving force. The heat transfer block and the heater block are allowed to change attitude in a facilitated manner.

The method may further comprise: obtaining a first temperature information specifying temperature from a thermal sensor in the heat transfer block when the heat transfer block is heated; controlling heating of the heater block based on the first temperature information; bringing the heat transfer block in contact with the object when temperature of the heat transfer block in the first temperature information from the thermal sensor reaches a first temperature; obtaining a second temperature information specifying temperature from the thermal sensor when the heat transfer block is cooled; and separating the heat transfer block from the object based on the second temperature information. The heat transfer block is reliably allowed to reach a predetermined temperature based on the performance of the thermal sensor when the heat transfer block is heated. The heat transfer block is reliably cooled to a predetermined temperature based on the performance of the thermal sensor prior to separation of the heat transfer block from the object.

The method may further comprise: obtaining a third temperature information specifying temperature from a thermal sensor in the heater block when the heater block has been separated from the heat transfer block; and controlling the heating of the heater block based on the third temperature information. When the heater block is separated from the processing head, heating of the heater block is controlled based on the output from the thermal sensor in the heater block. The heater block is thus reliably prevented from an excessive rise in temperature during cooling of the heat transfer block.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating a processing apparatus, namely a solder bonding apparatus, according to an embodiment of the present invention;

FIG. 2 is an enlarged front sectional view of a heating head unit;

FIG. 3 is a block diagram schematically illustrating a control system for the solder bonding apparatus;

FIG. 4 is a perspective view schematically illustrating a carriage unit for a hard disk drive, set on the solder bonding apparatus;

FIG. 5 is an enlarged perspective view of the carriage unit;

FIG. 6 is an enlarged front sectional view, corresponding to FIG. 2, for schematically illustrating the heating head unit having a heater tip in contact with an inclined surface;

FIG. 7 is an enlarged front sectional view, corresponding to FIG. 2, for schematically illustrating the heating head unit separating a heater block from the heat tip in contact with the inclined surface;

FIG. 8 is an enlarged front sectional view, corresponding to FIG. 2, for schematically illustrating the heating head unit keeping a space between the heater tip and the heart block during the upward movement;

FIG. 9 is an enlarged front sectional view, corresponding to FIG. 2, for schematically illustrating a heating head unit according to another embodiment of the present invention; and

FIG. 10 is an enlarged front sectional view, corresponding to FIG. 2, for schematically illustrating a heating head unit according to still another embodiment of the present invention.

### DESCRIPTION OF THE PREFERRED EMBODIMENT

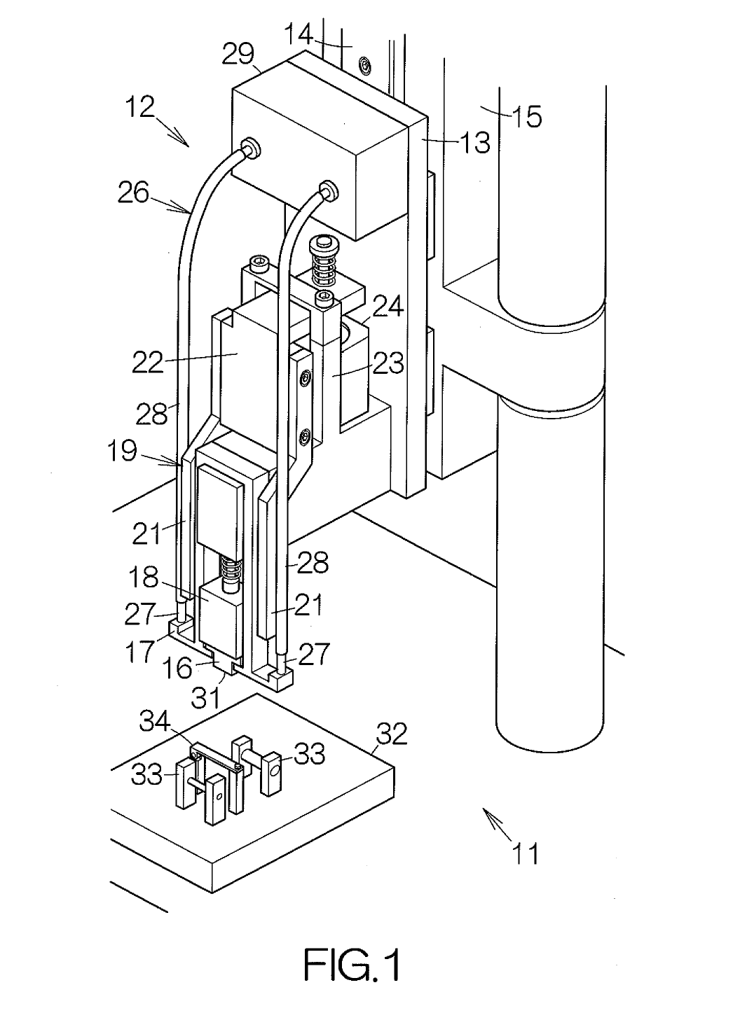

FIG. 1 schematically illustrates a processing apparatus, namely a solder bonding apparatus, according to an embodiment of the present invention. The solder bonding apparatus 11 includes a processing head unit, namely a heating head unit 12. The heating head unit 12 is fixed to a backplate 13. The backplate 13 is supported on a guide rail 14. The guide rail 14 extends in the vertical direction. The backplate 13 is designed to move in the vertical direction along the guide rail 14.

A power source, namely an actuator 15, is connected to the backplate 13. The actuator 15 applies a driving force to the backplate 13. The driving force from the actuator 15 allows the upward and downward movements of the backplate 13 in the vertical direction.

The heating head unit 12 includes a heater tip 16. The heater tip 16 is supported on a support member 17. The support member 17 is fixed to the backplate 13. The heater tip 16 serves as a processing head or a heat transfer block according to the present invention. A heater block 18 is placed on the upper surface of the heater tip 16. The heater tip 16 and the heater block 18 may be made of a metallic material having a high thermal conductivity. Such a metallic material may include molybdenum, tungsten or brass, for example. A hard chromium plating film may be formed to cover over the surface of the heater tip 16 and heater block 18 made of brass. The heater tip 16 and the heater block 18 will be described later in detail.

A lifting mechanism 19 is related to the heater block 18. The lifting mechanism 19 includes a pair of arm members 21 coupled to the heater block 18 at their tip ends as described later. The arm members 21 are fixed to a movable plate 22. The movable plate 22 is coupled to a guide mechanism 23. The guide mechanism 23 is designed to guide the movement of the movable plate 22 in the vertical direction.

The lifting mechanism 19 includes a cylinder 24. The cylinder 24 serves to apply a driving force to the movable plate 22. The movable plate 22 is allowed to move upward and downward in the vertical direction based on the applied driving force. The guide mechanism 23 and the cylinder 24 are supported on the support member 17.

A ventilation mechanism 26 is related to the heater tip 16. The ventilation mechanism 26 includes a pair of flexible pipes 28 coupled to nipples 27 of the support member 17, respectively. An air pump 29 is connected to the flexible pipes 28. The air pump 29 supplies air into the flexible pipes 28. The air pump 19 is attached to the backplate 13.

The tip end of the heater tip 16 defines a flat contact surface 31. The contact surface 31 is opposed to a stage 32. The stage 32 is designed to move along a horizontal plane. The stage 32 is positioned based on a rectangular coordinate system defined within the horizontal plane.

A carriage receiver 33 is fixed on the stage 32. The carriage receiver 33 is designed to receive a carriage unit employed in a hard disk drive. The carriage receiver 33 is expected to fix the carriage unit on the stage 32. A jig 34 is also fixed on the stage 32. When a carriage unit is received on the carriage receiver 33, the jig 34 serves to hold flexible printed wiring boards of head suspensions, as described later.

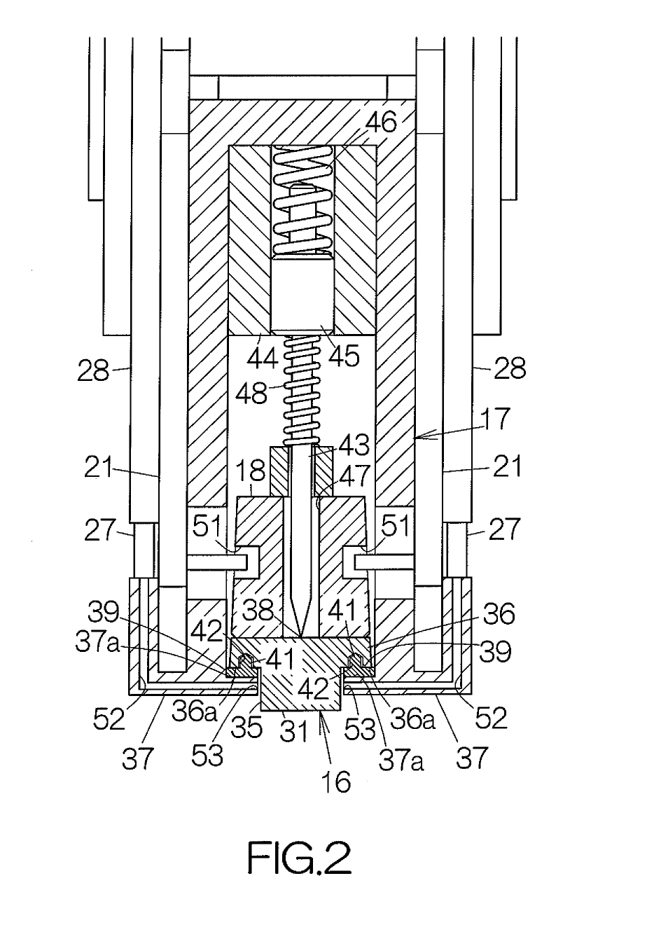

As shown in FIG. 2, the heater tip 16 includes a tip block 35 defining the contact surface 31 at its lower end. An enlarged block 36 is coupled to the upper end of the tip block 35. The tip block 35 and the enlarged block 36 may be formed integral to each other. The enlarged block 36 extends outward at least in the lateral direction from the tip block 35. The enlarged block 36 defines a flat surface or surfaces 36a facing downward. The flat surface 36a extends in parallel with the contact surface 31. The enlarged block 36 is formed in a shape tapered in the upward direction.

The support member 17 defines a pair of horizontal pieces 37 supporting the weight of the enlarged block 36 at a position adjacent to the tip block 35. The horizontal pieces 37 serve to support the enlarged block 36 upward from below. The tip block 35 projects downward from a space between the horizontal pieces 37. The contact surface 31 of the tip block 35 is thus placed at a position below the lower surfaces of the horizontal pieces 37. The individual horizontal piece 37 defines a horizontal surface 37a facing upward. The horizontal surfaces 37a of the horizontal pieces 37 are opposed to the flat surface or surfaces 36a of the enlarged block 36. A predetermined space is defined between the individual horizontal piece 37 and the tip block 35. The heater tip 16 is thus allowed to change its attitude around a pivot point 38.

An insulating member 39 is placed on the individual horizontal surface 37a. The insulating member 39 may be made of a material having a relatively low thermal conductivity. Such a metallic material includes stainless steel, for example. A positioning pin 41 is formed on the surface of the individual insulating member 39. The positioning pin 41 stands upright from the surface of the corresponding insulating member 39 in the vertical direction. The upper end of the individual positioning pin 41 is formed in the shape of a cone. The peaks of the cones of the positioning pins 41 are positioned within a horizontal plane.

Receiving bores 42 are formed in the flat surface or surfaces 36a of the enlarged block 36. The positioning pins 41 are received in the corresponding receiving bores 42, respectively. A cone-shaped depression is formed in the bottom of the individual receiving bore 42. An interval between the peaks of the cone of the cone-shaped depression is set equal to the interval between the peaks of the positioning pins 41. In addition, the equal depth is set for the receiving bores 42. When the tip ends of the positioning pins 41 are received at the deepest bottoms of the receiving bores 42, the heater tip 16 is set in a horizontal attitude. The contact surface 31 is in this manner held within a horizontal plane.

An urging member 43 is related to the heater tip 16. The urging member 43 includes a shaft member extending in the vertical direction. The urging member 43 may be made of a metallic material having a relatively low thermal conductivity. Such a metallic material includes stainless steel, for example. The tip end of the urging member 43 is formed in the shape of a cone, for example. The urging member 43 contacts with the upper surface of the heater tip 16 only at the pivot point 38. Point contact is thus established between the urging member 43 and the upper surface of the heater tip 16. The urging member 43 is supported on a receiving member 44 for relative vertical movement. The receiving member 44 is fixed to the support member 17.

A flange member 45 is mounted on the urging member 43. The flange member 45 is fixed to the urging member 43 so that the axial movement of the flange member 45 is restricted. An elastic member, namely a first coil spring 46, is interposed between the flange member 45 and the downward surface of the support member 17. The first coil spring 46 may be made of a metallic material having a relatively low thermal conductivity. Such a metallic material includes stainless steel, for example. The compressed first coil spring 46 serves to distance the urging member 43 downward away from the downward surface of the support member 17 in the vertical direction. A downward urging force is applied to the heater tip 16 in the vertical direction based on the elastic force of the compressed first coil spring 46. The heater tip 16 is thus urged against the horizontal pieces 37 of the support member 17.

A through hole 47 is formed in the heater block 18. The through hole 47 extends in the vertical direction. The urging member 43 extends through the through hole 47. A predetermined play is defined between the through hole 47 and the urging member 43. The predetermined play serves to allow the heater block 18 to change its attitude around the pivot point 38. The heater block 18 is allowed to follow a change in the attitude of the heater tip 16. The heater block 18 is formed in a shape tapered in the upward direction.

An elastic member, namely a second coil spring 48, is interposed between the upward surface of the heater block 18 and the flange member 45. The second coil spring 48 may be made of a metallic material having a relatively low thermal conductivity. Such a metallic material includes stainless steel, for example. The compressed second coil spring 48 serves to distance the heater block 18 downward away from the flange member 45 in the vertical direction. A downward urging force is applied to the heater block 18 based on the elastic force of the compressed second coil spring 48. The elastic force of the compressed second coil spring 48 is set significantly smaller than that of the compressed first coil spring 46. The entire downward surface of the heater block 18 is in this manner urged against the upward surface of the heater tip 16. The heater block 18 is brought in contact with the heater tip 16.

The heater block 18 defines a pair of lateral holes 51 opened at the side vertical surface of the heater block 18. The tips ends of the aforementioned arm members 21 are inserted in the lateral holes 51, respectively. When the movable plate 22 is positioned at the lowermost position through the operation of the cylinder 24, a play is defined between the arm members 21 and the inner walls of the lateral holes 51, respectively. The heater block 18 is thus allowed to change its attitude. The heater block 18 is prevented from contacting with the arm members 21 during a change in the attitude of the heater block 18. When the movable plate 22 moves from the lowermost position toward the uppermost position through the operation of the cylinder 24, the space is eliminated between the arm members 21 and the inner walls of the corresponding lateral holes 51, respectively. The arm members 21 engage with the lateral holes 51, respectively. When the movable plate 22 thereafter reaches the uppermost position, the heater block 18 is lifted. The heater block 18 is separated from the heater tip 16.

The ventilation mechanism 26 includes two passages 52 defined in the support member 17. One end of the individual passage 52 is connected to the aforementioned nipple 27. The other end of the individual passage 52 defines an opening 53 opposed to the surface of the heater tip 16. Air within the flexible pipes 28 is discharged toward the heater tip 16 through the openings 53 of the passages 52.

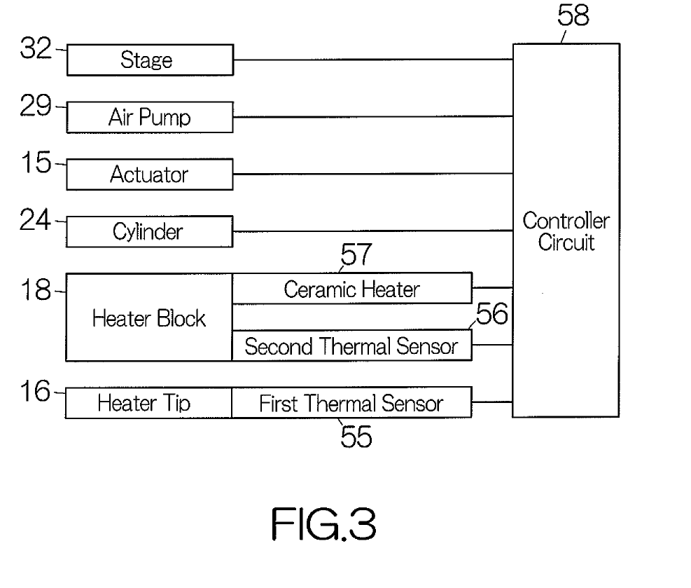

As shown in FIG. 3, a first thermal sensor 55 is incorporated in the heater tip 16. The first thermal sensor 55 is utilized to detect the temperature of the heater tip 16. The first thermal sensor 55 outputs a first temperature information signal. The first temperature information signal specifies the measurement result of the first temperature sensor 55.

A second thermal sensor 56 is incorporated in the heater block 18. The second thermal sensor 56 is utilized to detect the temperature of the heater block 18. The second temperature sensor 56 outputs a second temperature information signal. The second temperature information signal specifies the measurement result of the second thermal sensor 56.

A ceramic heater 57 is coupled to the heater block 18, for example. The ceramic heater 57 may be embedded within the heater block 18, for example. The ceramic heater 57 is utilized to heat the heater block 18.

A controller circuit 58 is connected to the ceramic heater 57. The controller circuit 58 is designed to control the temperature of heat generated at the ceramic heater 57. The controller circuit 58 obtains the first and second temperature information signals from the first and second thermal sensors 55, 56 to control the ceramic heater 57. The controller circuit 58 is designed to execute controls or processing based on a predetermined software program, as described later. Such a software program may be stored in an internal memory in the controller circuit 58, for example.

The cylinder 24, the actuator 15, the air pump 29 and the stage 32 are connected to the controller circuit 58. The controller circuit 58 is designed to control the cylinder 24, the actuator 15, the air pump 29 and the stage 32. The aforementioned software program is utilized to control the cylinder 24, the actuator 15, the air pump 29 and the stage 32.

Next, description will be made on the operation of a solder bonding apparatus 11. The solder bonding apparatus 11 is first initialized prior to the start of the operation. The initialized status sets the movable plate 22 at the lowermost position. Specifically, the cylinder 21 is kept at rest. The arm members 21 are disengaged from the heater block 18. The first coil spring 46 serves to apply an urging force to the heater tip 16 at the pivot point 38 through the urging member 43. The tip ends of the positioning pins 41 are received on the deepest bottoms of the receiving bores 42. The heater tip 16 is thus set in the horizontal attitude. The contact surface 31 is kept to extend within the horizontal plane. The second coil spring 48 serves to allow the lower flat surface of the heater block 18 to uniformly contact with the upper flat surface of the heater tip 16. The heater block 18 and the heater tip 16 in this manner contact with each other over a large contact area. The actuator 15 serves to hold the support member 17 at a relatively high position. The air pump 29 is kept at rest.

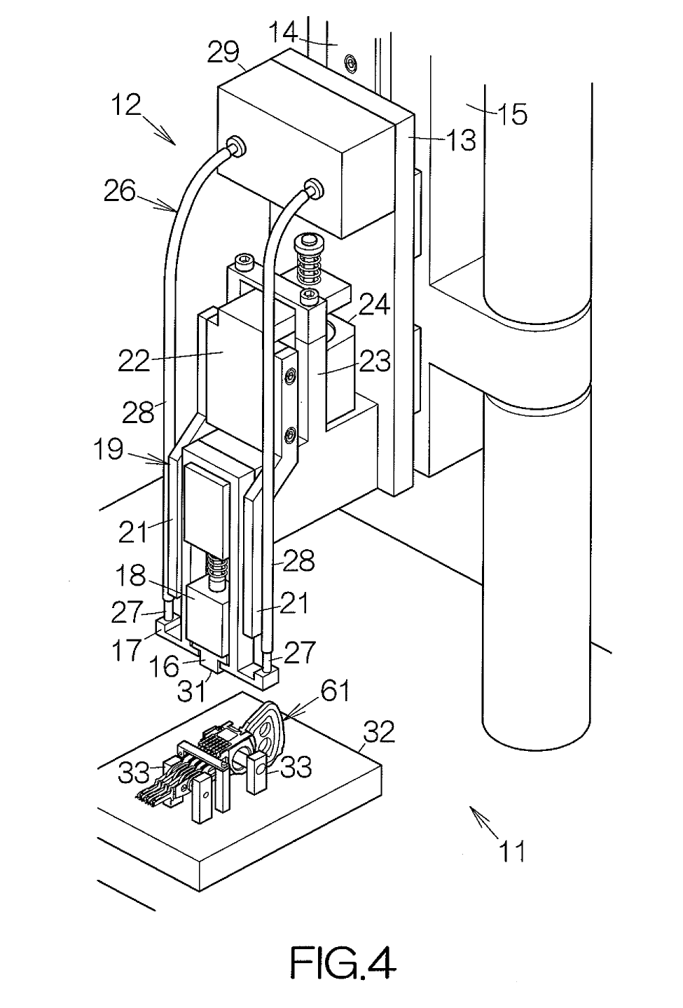

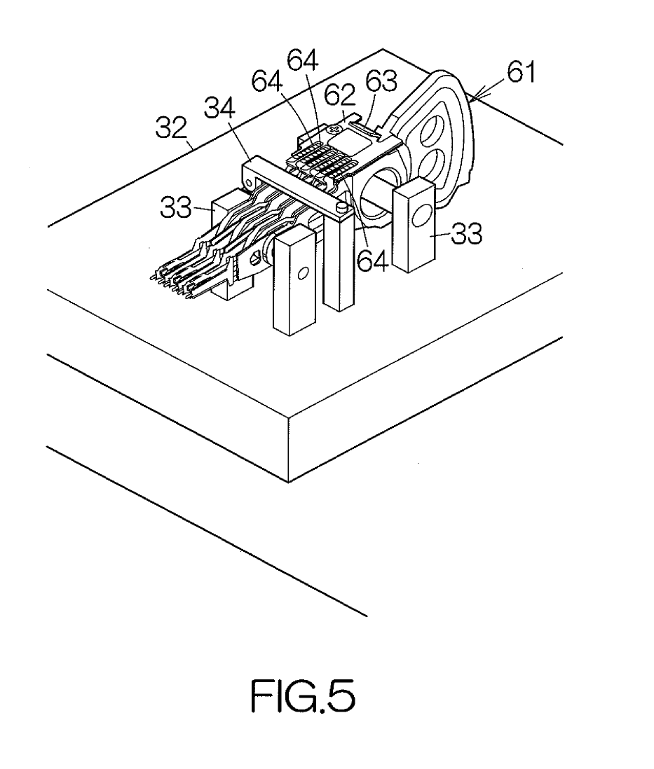

As shown in FIG. 4, a carriage unit 61 for a hard disk drive is set on the solder bonding apparatus 11. The carriage unit 61 is fixed to the carriage receiver 33. As shown in FIG. 5, the carriage unit 61 includes a first flexible printed wiring board 62 overlaid on the surface of a carriage block. The first flexible printed wiring board 62 is backed with a thin plate 63 made of aluminum. The backed back surface of the first flexible printed wiring board 62 is received on the surface of the carriage block. Rows of electrically-conductive pads are formed on the front surface of the first flexible printed wiring board 62. Soldering paste is applied to the individual electrically-conductive pads.

Second flexible printed wiring boards 64 are placed on the first flexible printed wiring board 62. The second flexible printed wiring board 64 is assigned to the row of the electrically-conductive pads. A jig 34 is utilized to hold the second flexible printed wiring boards 64. The jig 34 serves to urge the second flexible printed wiring boards 64 against the corresponding rows of the electrically-conductive pads, respectively. The electrically-conductive terminals of the individual second flexible printed wiring board 64 are in this manner placed on the corresponding electrically-conductive pads, respectively.

When the setting of the carriage unit 61 is completed, an operator switches on the solder bonding apparatus 11. The controller circuit 58 starts controls or processing based on the software program. The controller circuit 58 first operates to position the stage 32. A section including all the electrically-conducive terminals on the carriage unit 61 is opposed to the contact surface 31 of the heater tip 16. The controller circuit 58 then operates to control the operation of the ceramic heater 57. The ceramic heater 57 generates heat transferred to the heater block 18 and the heater tip 16. The temperature of the heater tip 16 rises. The controller circuit 58 refers to the first temperature information signal from the first thermal sensor 55 for controlling the ceramic heater 57. The controller circuit 58 sets a first target temperature at a first temperature (350 degrees Celsius, for example). The first temperature may be set higher than the melting point of solder. The temperature of the heater tip 16 rises to the first temperature.

When the temperature of the heater tip 16 reaches the first temperature, the controller circuit 58 operates to instruct the downward movement of the heating head unit 12. The controller circuit 58 outputs a predetermined control signal to the actuator 15. The heater tip 16 is driven to move downward to the electrically-conductive terminals on the second flexible printed wiring boards 64.

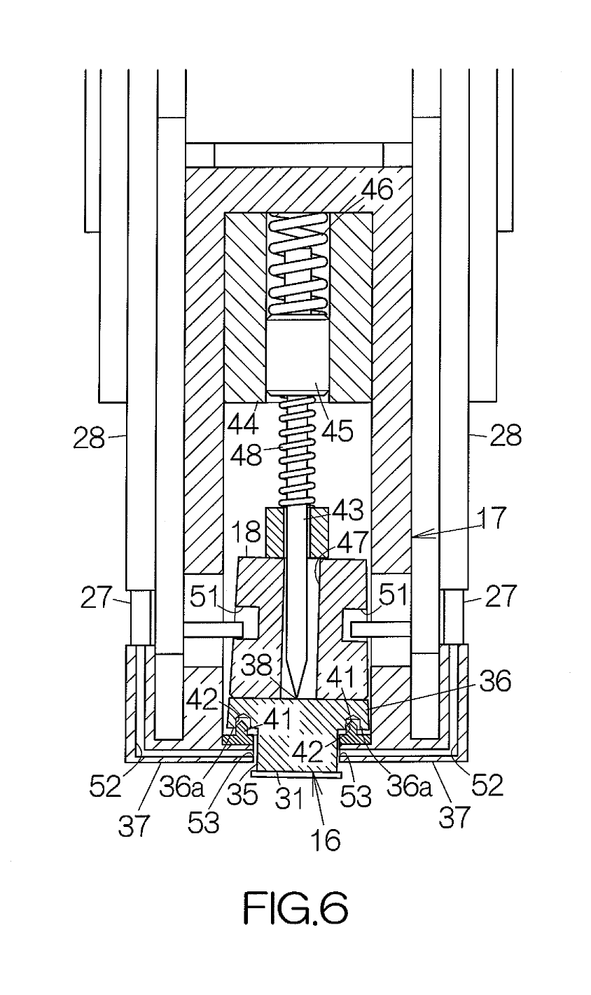

As shown in FIG. 6, when the heater tip 16 is driven downward in the vertical direction, the tip end of the heater tip 16 abuts against the electrically-conductive terminals. Here, the controller circuit 58 operates to keep the support member 17 moving downward. The actuator 15 maintains the driving force. The heater tip 16 gets spaced from the positioning pins 41 in response to the reaction against the carriage unit 61. The first coil spring 46 compresses. The contact surface 31 of the heater tip 16 is allowed to follow the inclined surface of the carriage unit 61. The contact surface 31 inclines from a horizontal plane. The inclination of the heater tip 16 induces the corresponding inclination of the heater block 18. The heater tip 16 is thus kept in uniform contact with the heater block 18. The contact surface 31 uniformly contacts with all the electrically-conductive terminals arranged in the inclined surface. Heat is equally transferred from the heater tip 16 to the electrically-conductive terminals. The contact of the heater tip 16 is kept for a predetermined period of time (five seconds, for example) The solder correspondingly melts on all the electrically-conductive terminals. The temperature of the heater tip 16 may be kept at the aforementioned first temperature based on the utilization of the first thermal sensor 55.

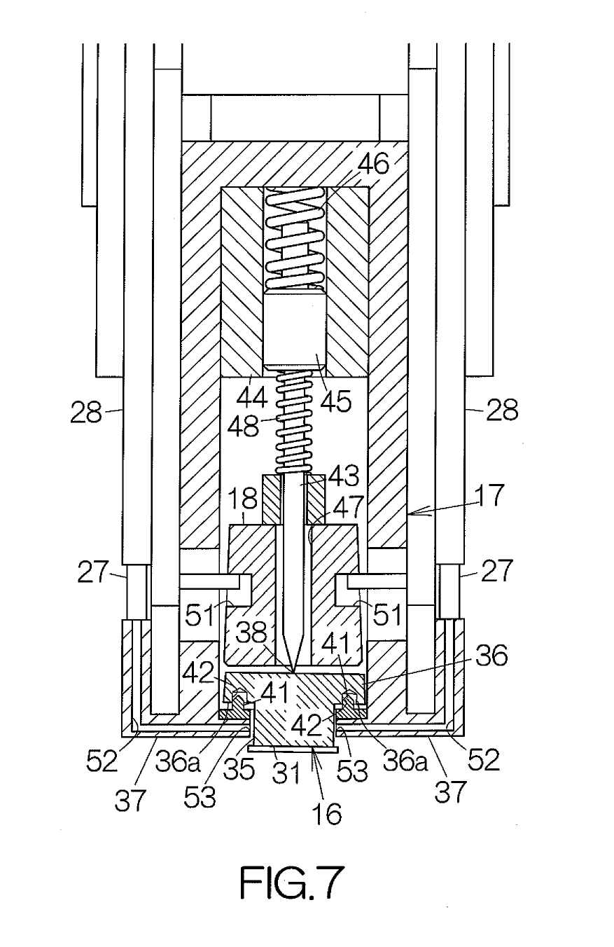

When the predetermined period of time lapses, the controller circuit 58 operates to lift the arm members 21 upward. The controller circuit 58 supplies a predetermined control signal to the cylinder 24. The arm members 21 are moved upward in the vertical direction. As shown in FIG. 7, the arm members 21 are forced to engage with the lateral holes 51 of the heater block 18. The heater block 18 is thus lifted upward in the vertical direction. The second coil spring 48 thus compresses. Since the elastic force of the second coil spring 48 is set significantly smaller than that of the first coil spring 46, the first coil spring 46 still keeps applying the urging force to the heater tip 16 regardless of the compression of the second coil spring 48. The heater tip 16 is kept in contact with the electrically-conductive terminals. The heater block 18 is in this manner separated from the heater tip 16. The transfer of the heat is cut off between the heater block 18 and the heater tip 16. The temperature of the heater tip 16 thus starts dropping. The controller circuit 58 operates to instruct the activation of the air pump 29. Air is discharged to the heater tip 16 through the openings 53. Cooling of the heater tip 16 is accelerated. The temperature of the heater tip 16 in this manner falls.

The controller circuit 58 monitors the temperature of the heater tip 16. The controller circuit 58 sets a second target temperature at a second temperature (200 degrees Celsius, for example). The second temperature may be set lower than the freezing point of the solder. When the temperature of the heater tip 16 sufficiently drops, the solder solidifies or gets hardened. The individual second flexible printed wiring boards 64 are thus bonded to the first flexible printed wiring board 62 on the carriage block. When the second temperature is detected based on the first temperature information signal, the controller circuit 58 confirms the solidification of the solder.

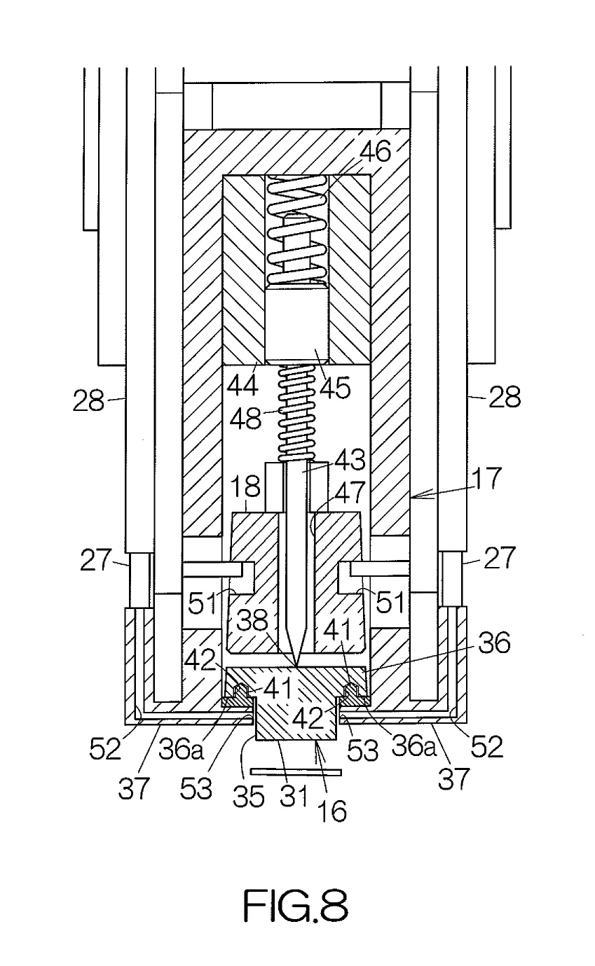

The controller circuit 58 thereafter operates to instruct the upward movement of the heating head unit 12. The controller circuit 58 outputs a predetermined control signal to the actuator 15. The support member 17 is driven upward in the vertical direction. As shown in FIG. 8, the tip ends of the positioning pins 41 are received on the deepest bottoms of the pin holes 42. The heater tip 16 is thus supported on the horizontal pieces 37 from below in the vertical direction. The heater tip 16 is again set in the horizontal attitude. A further upward movement of the support member 17 induces the upward movement of the heater tip 16. The heater tip 16 is separated from the electrically-conductive terminals on the second flexible printed wiring boards 64. Simultaneously, the controller circuit 58 operates to instruct the stoppage of the air pump 29. The air pump 29 returns to the resting state.

While the heater tip 16 is cooled down, the ceramic heater 57 is kept controlled. The controller circuit 58 refers to the second temperature information signal of the second thermal sensor 56. The controller circuit 58 serves to maintain the aforementioned first target temperature (first temperature), for example. The temperature of the heater block 18 is thus kept at the first temperature. Here, the first thermal information signal of the first thermal sensor 55 specifies the temperature of the heater tip 16. Accordingly, if the ceramic heater 57 is controlled based on the first temperature information signal, the ceramic heater 57 tends to suffer from an excessive rise in temperature. The reference to the second temperature information signal at the controller circuit 58 to control the ceramic heater 57 enables a reliable prevention of an excessive rise in temperature of the ceramic heater 57.

When the heating head unit 12 returns to the initial position, the controller circuit 58 operates to return the arm members 21 to the lowermost positions. The heater block 18 is thus set on the heater tip 16. The heater block 18 is supported on the heater tip 16. Since the temperature of the heater block 18 is kept at the first temperature as described above, the heater tip 16 is immediately heated. The heater tip 16 can alternately be subjected to heating and cooling in a shorter period.

The controller circuit 58 subsequently operates to drive the stage 32 in the horizontal direction. The stage 32 is moved out of a space opposed to the heating head unit 12. The carriage unit 61 is then removed from the carriage receiver 33. Another carriage unit 61 is subsequently set. The operation of the solder bonding apparatus 11 can be repeated again and again in this manner.

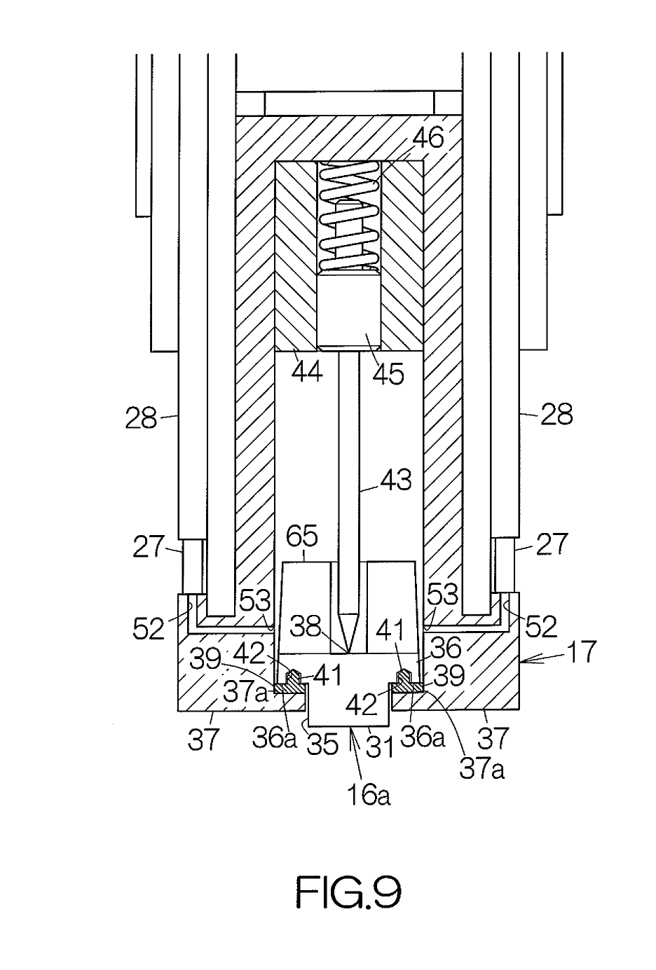

The solder bonding apparatus 11, as shown in FIG. 9, for example, may utilize a heated airflow to heat a heater tip. The heated airflow may be directed to a heater tip 16a through the openings 53, for example. Fins 65 may be formed on the heater tip 16a in a flow passage of the heated airflow. The heat of the heated airflow is efficiently transferred to the heater tip 16a through the fins 65. Airflow of a low temperature (the room temperature) may be directed to the heater tip 16a through the openings 53 for cooling the heater tip 16a in the same manner as described above. Like reference numerals are attached to the structure or components equivalent to those of the aforementioned embodiment.

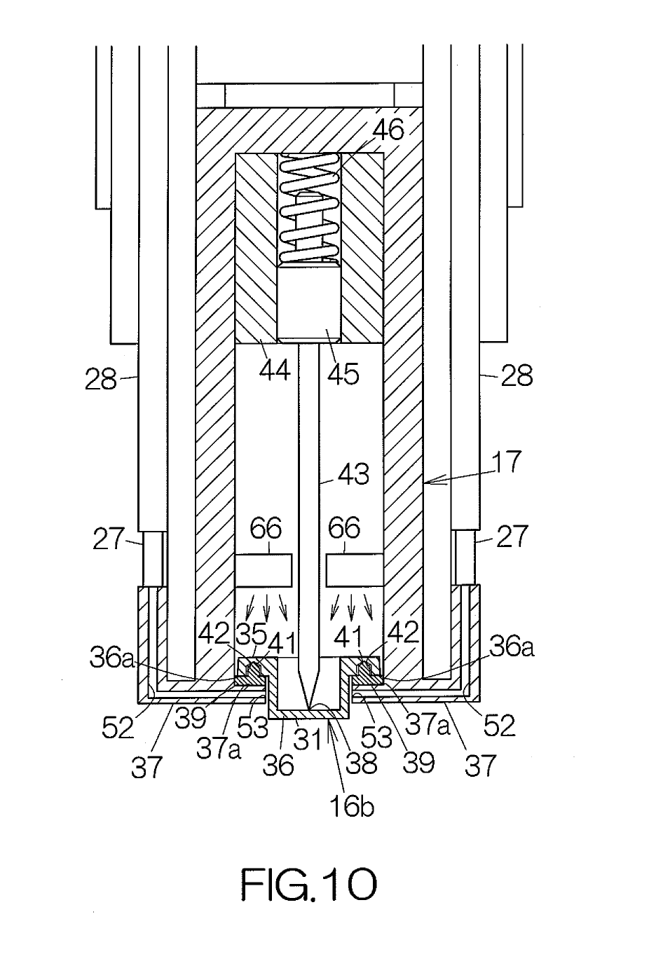

As shown in FIG. 10, for example, a halogen lamp 66 may be utilized for heating a heater tip. The halogen lamp 66 may be opposed to the surface of a heater tip 16b. As is obvious from FIG. 10, the heater tip 16b is preferably made thinner to the utmost. Like reference numerals are attached to the structure or components equivalent to those of the aforementioned embodiment.

What is claimed is:

1. A processing apparatus comprising:
a processing head supported for relative movement around a pivot point; and
an urging member applying an urging force to the processing head at the pivot point.

2. The processing apparatus according to claim 1, further comprising:
a support member supporting weight of the processing head, said support member allowing a tip end of the processing head to project downward in a vertical direction; and
a driving mechanism enabling upward and downward movements of the support member in the vertical direction.

3. The processing apparatus according to claim 2, further comprising a heater block brought in contact with the processing head for heating the processing head to a predetermined temperature.

4. The processing apparatus according to claim 3, further comprising a lifting mechanism designed to lift the heater block in the vertical direction.

5. The processing apparatus according to claim 4, further comprising a ventilation mechanism enabling discharge of airflow from an opening opposed to a surface of the processing head.

6. The processing apparatus according to claim 5, further comprising:
a first thermal sensor incorporated in the processing head; and
a second thermal sensor incorporated in the heater block.

7. A method of controlling a heating apparatus, comprising:
heating a heat transfer block to a predetermined temperature using a heater block in contact with the heat transfer block, said heat transfer block being brought into contact with an object; and
separating the heater block from the heat transfer block for cooling the heat transfer block.

8. The method according to claim 7, wherein a temperature of the heater block is kept at a predetermined temperature while the heat transfer block is cooled.

9. The method according to claim 8, further comprising:
obtaining a first temperature information specifying temperature from a thermal sensor in the heat transfer block when the heat transfer block is heated;
controlling heating of the heater block based on the first temperature information;
bringing the heat transfer block in contact with the object when temperature of the heat transfer block in the first temperature information from the thermal sensor reaches a first temperature;
obtaining a second temperature information specifying temperature from the thermal sensor when the heat transfer block is cooled; and
separating the heat transfer block from the object based on the second temperature information.

10. The method according to claim 9, further comprising:
obtaining a third temperature information specifying temperature from a thermal sensor in the heater block when the heater block has been separated from the heat transfer block; and
controlling the heating of the heater block based on the third temperature information.
